(19) United States
(12) Patent Application Publication
(10) Pub. No.: US 2017/0282773 A1
(43) Pub. Date: Oct. 5, 2017

(54) CUP HOLDER FOR VEHICLE AND VEHICLE COMPRISING SAME

(71) Applicant: DAE CHANG CO., LTD., Jeongeup-si (KR)

(72) Inventors: Jun Dong JI, Suwon-si (KR); Myeong Ji O, Hwaseong-si (KR)

(21) Appl. No.: 15/514,501

(22) PCT Filed: Oct. 17, 2014
(86) PCT No.: PCT/KR2014/009804

§ 371 Date: Mar. 25, 2017

(30) Foreign Application Priority Data
Sep. 25, 2014 (KR) 10-2014-0128531
Oct. 14, 2014 (KR) 10-2014-0138308
Oct. 17, 2014 (KR) 10-2014-0140830

(51) Int. Cl. B60N 3/10

(52) U.S. Cl. CPC B60N 3/104; B60N 3/101

(57) ABSTRACT

A cup holder for a vehicle includes a heating unit configured to prevent a heater and a conductive plate from being separated from each other due to vibrations of the vehicle or aging degradation. The cup holder for a vehicle includes: a housing for accommodating a cup or container; and a heating unit disposed at a portion of a side wall of the housing, in which the heating unit is provided with a thermally conductive plate and a plane heater fixedly disposed on one surface or in the inside of the thermally conductive plate.

### TECHNICAL FIELD

Exemplary embodiments of the present invention relate to a cup holder for a vehicle and a vehicle including the same, and more particularly, to a cup holder for a vehicle capable of heating a drink container accommodated in the cup holder, and a vehicle including the same.

### BACKGROUND ART

A cup holder for a vehicle is an automobile component that is generally formed in a console box, an armrest, a center fascia, or the like of a vehicle, or installed in a various forms to accommodate a cup or other drink containers of passengers. Further, the cup holder for a vehicle may also have a function of keeping contents warm or cool, the contents being accommodated in a cup or container that is accommodated in the cup holder, like a drink.

The cup holder is generally configured to keep contents warm or cool by heating or cooling an accommodated cup or container by using a thermoelectric element module disposed at a bottom portion of the cup holder, but in this case, power consumption of the thermoelectric element module is large, a cooling apparatus like a fan is needed, and a configuration of the cup holder is complicated (see Patent Document 2).

In addition, the cup holder for a vehicle continuously suffers from vibrations generated during driving of the vehicle over a long period of time, and is used for a long time like a service life of the vehicle, therefore, there may be a problem that a connection state or a contact state of a heating element like a thermoelectric element module and a heat transfer part made of metal deteriorates due to vibrations and aging degradation, causing heat not to be properly transferred. Further, even though the thermoelectric element module and the heat transfer part are adhered to each other by an adhesive, an adhesive layer interposed between the thermoelectric element module and the heat transfer part may act as an insulating layer, thereby making heat transfer therebetween difficult.

### RELATED ART DOCUMENT

### Patent Document

(Patent Document 1) Korean Utility Model Laid-Open Publication No. 20-1999-0040122 (Nov. 25, 1999)
(Patent Document 2) Korean Patent Laid-Open Publication No. 10-2006-0114593 (Nov. 7, 2006)
(Patent Document 3) Korean Patent Laid-Open Publication No. 10-2010-0130513 (Dec. 13, 2010)
(Patent Document 4) Korean Patent Publication No. 10-1421929 (Jul. 16, 2014)

### DISCLOSURE

### Technical Problem

An object of the present invention is to provide a cup holder for a vehicle, the cup holder having a heating unit configured so as to prevent a heater and a conductive plate from being separated from each other due to vibrations of the vehicle or aging degradation.

Another object of the present invention is to provide a cup holder for a vehicle, the cup holder having a heating unit configured to effectively transfer heat generated in a heater to a conductive plate.

Another object of the present invention is to provide a cup holder for a vehicle, the cup holder having a heating unit in which a heater may be easily buried in a conductive plate.

Another object of the present invention is to provide a cup holder for a vehicle, the cup holder having a heating unit in which a plate having a heater buried therein may radiate a larger amount of heat.

Another object of the present invention is to provide a vehicle including the cup holder for a vehicle as described above.

However, technical objects of the present invention are not limited to the above-mentioned objects. Other objects that are not mentioned above could be obviously understood by those skilled in the art from the following description.

### Technical Solution

In accordance with one aspect of the present invention, a cup holder for a vehicle includes: a housing for accommodating a cup or container; and a heating unit disposed at a portion of a side wall of the housing, in which the heating unit is provided with a thermally conductive plate and a plane heater fixedly disposed on one surface or in the inside of the thermally conductive plate.

The thermally conductive plate may be formed of metal, and formed with an insertion hole that is compressed after the plane heater is inserted thereinto so that the plane heater is buried in the thermally conductive plate.

The thermally conductive plate may include a first thermally conductive surface and a second thermally conductive surface that contact the cup or container accommodated in the housing, the first thermally conductive surface and the second thermally conductive surface being connected to each other at an angle of less than 180 degrees.

The thermally conductive plate may include a first thermally conductive surface and a second thermally conductive surface that contact the cup or container accommodated in the housing, the first thermally conductive surface and the second thermally conductive surface being connected to each other at an angle of less than 180 degrees, and the insertion hole may be formed to have a bent shape while being adjacent to the first and second thermally conductive surfaces.

The thermally conductive plate may include a first thermally conductive surface and a second thermally conductive surface that are connected to each other at an angle of less than 180 degrees, and may further include a rear surface facing the first and second thermally conductive surfaces, and the insertion hole may be formed to have a straight line shape while being adjacent to the rear surface.

The insertion hole may be formed to have a wave shape or a zigzag shape.

A bent part that may be bent when the insertion hole is compressed may be formed at a portion adjacent to at least one of both ends of the insertion hole of the thermally conductive plate.

The cup holder for a vehicle may further include an insulation member disposed at a surface, of both surfaces of the plane heater buried in the thermally conductive plate, that is far from a surface of the thermally conductive plate facing the cup or container accommodated in the housing.

At least one of the first thermally conductive surface and the second thermally conductive surface may be formed with a cutout part.

The cup holder for a vehicle may further include a bottom part integrally formed with the thermally conductive plate.

The cup holder for a vehicle may further include a lighting part disposed to be adjacent to a circumference of an opened upper end portion of the housing, and emitting light with a first color when power is supplied to the plane heater, in which the lighting part may emit light with a second color when night lighting is turned on in the vehicle, and emit light with the first color when power is supplied to the plane heater.

The plane heater may be a positive temperature coefficient (PTC) heater.

The thermally conductive plate may be formed of thermally conductive plastic, and the plane heater may be buried in the thermally conductive plate or adhered to one surface of the thermally conductive plate by insert injection-molding or insert molding.

The plane heater may be bonded to the thermally conductive plate with a thermally conductive adhesive.

In accordance with another aspect of the present invention, a cup holder for a vehicle includes a housing accommodating a cup or container and formed of metal, in which at least a portion of the housing is provided with a far-infrared ray coating layer for generating far-infrared ray.

In accordance with still another aspect of the present invention, a cup holder for a vehicle includes: a housing for accommodating a cup or container, in which a side wall portion of the housing has a predetermined gradient to facilitate contact with the cup or container.

The cup holder for a vehicle may further include a far-infrared ray generating member provided in the housing.

The cup holder for a vehicle may further include a plane heating element provided in the housing.

The cup holder for a vehicle may further include a Peltier element provided in the housing.

In accordance with still yet another aspect of the present invention, there is provided a cup holder for a vehicle, in which air heated by a heater and a heat exchanging fin is supplied to an inside of a housing by an air-blowing fan to heat an accommodated item accommodated in the housing.

In accordance with still yet another aspect of the present invention, there is provided a cup holder for a vehicle including a plane heater, a heat exchanger, an air-blowing fan, and a housing, the housing having an air vent formed therein, in which an accommodated item accommodated in the housing is heated by at least one of heat transfer and heated air.

A coating for generating far-infrared ray may be formed on the cup holder for a vehicle.

In accordance with still yet another aspect of the present invention, a cup holder for a vehicle includes: a housing for accommodating a cup or container; a heat exchanger mounted at the housing to transfer heat to the cup or container accommodated in the housing and heat air outside the housing; an air-blowing fan disposed to be adjacent to the heat exchanger; and an air guide part guiding air to flow from the housing to the heat exchanger, in which the housing is formed with a hole through which air is introduced and an outlet through which air is discharged, and the air guide part is formed from the outlet of the housing to the hole of the housing, such that the air heated by the heat exchanger is supplied to an inside of the housing by the air-blowing fan through the hole of the housing and air in the inside of the housing is discharged through the outlet to the outside of the housing and flows to the heat exchanger again.

The air guide part may be formed by a cup holder body accommodating the housing, the heat exchanger, and the air-blowing fan therein, or by an independent duct.

The cup holder for a vehicle may further include a flow path guide part disposed to face the heat exchanger while being spaced apart from the heat exchanger, in which a part of the air guide part is formed by the heat exchanger and the flow path guide part.

In accordance with another aspect of the present invention, there is provided a vehicle including the cup holder for a vehicle described above.

### DESCRIPTION OF DRAWINGS

FIG. 1 is an exploded perspective view of a cup holder according to an exemplary embodiment of the present invention.

FIG. 2 is a perspective view of a heating unit according to an exemplary embodiment of the present invention.

FIGS. 3A to 3C are plan views of heating units according to various exemplary embodiments of the present invention.

FIG. 4 is a perspective view of a heating unit according to another exemplary embodiment of the present invention.

FIG. 5 is a front view of a heating unit according to still another exemplary embodiment of the present invention.

FIG. 6 is a perspective view of a cup holder according to the present invention that is installed in a vehicle.

FIG. 7 is a circuit diagram of a lighting part according to an exemplary embodiment of the present invention.

FIG. 8A is a cross-sectional view of a cup holder for a vehicle according to still yet another exemplary embodiment of the present invention, and FIG. 8B is a partial exploded perspective view of the cup holder.

### BEST MODE

Hereinafter, exemplary embodiments of the present invention will be described with reference to the accompanying drawings. However, the exemplary embodiments are merely illustrative and the present invention is not limited thereto.

In describing the present invention, when a detailed description of well-known technology relating to the present invention may unnecessarily obscure the spirit of the present invention, a detailed description thereof will be omitted.

Further, the following terminologies are defined in consideration of the functions in the present invention and may be construed in different ways by the intention of users and operators. Therefore, the definitions thereof should be construed based on the contents throughout the specification.

As a result, the spirit of the present invention is defined by the claims and the following exemplary embodiments may be provided to efficiently describe the spirit of the present invention to those skilled in the art.

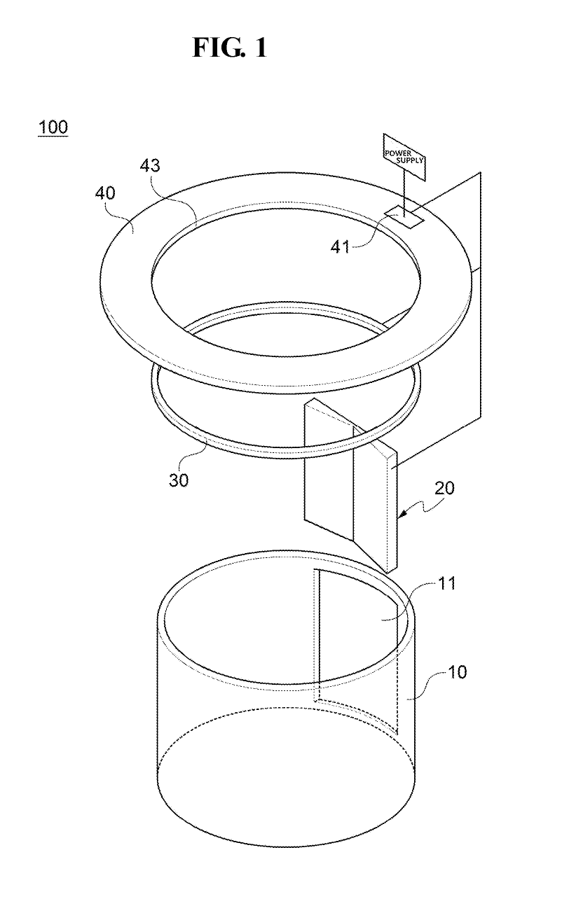

FIG. 1 is a schematic exploded perspective view of a cup holder according to an exemplary embodiment of the present invention.

As illustrated in FIG. 1, a cup holder 100 according to an exemplary embodiment of the present invention includes a housing 10 and a heating unit 20. In addition, the cup holder 100 may further include a lighting part 30 and a ring cover 40.

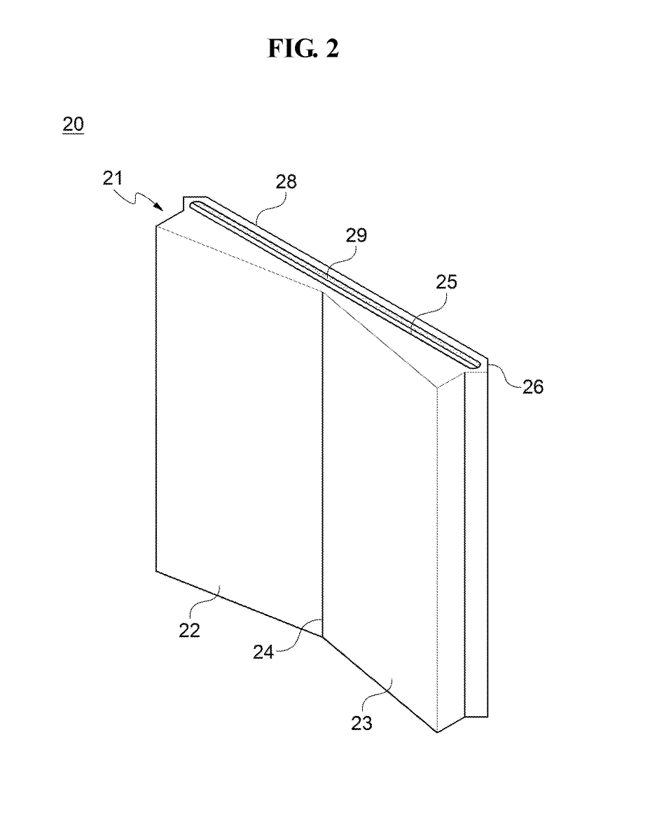

The housing 10 may accommodate a cup or container 1 (see FIG. 6) to be inserted therein. A cutout part 11 corresponding to a portion where the heating unit 20 is installed may be formed at a side wall of the housing 10. For example, grooves may be provided at both sides of the cutout part 11, such that both ends of the heating unit 20, for example, bent parts 26 (see FIG. 2) may be fitted into the grooves. A cross section of the housing 10 may have a circular shape, or may also have an oval shape, or other polygonal shapes. The housing 10 may be manufactured by injection-molding with a resin. In addition, a flange part (not illustrated) is provided at an opened upper end portion of the housing 10, and the lighting part 30 may be disposed thereon.

Further, an outer surface of the housing 10 may be further provided with a fastening part for fixing the housing 10 when the housing 10 is installed in the console box, the armrest, the center fascia, or the like in the vehicle.

Further, another cutout part may be formed at an opposite side of the side wall of the housing 10 to the cutout part 11, such that a pressurizing device capable of pressurizing the cup or container 1 accommodated in the housing 10 toward the heating unit 20 may be provided. A pressurizing device having a similar structure to those disclosed in Korean Patent Laid-Open Publication No. 10-2006-0058235, Korean Patent Laid-Open Publication No. 10-2006-0096620, etc. may be used, and this corresponds to a known technology, therefore, detailed description thereof will be omitted.

Further, the housing 10 may be formed of metal, and a far-infrared ray coating layer (not illustrated) that generates far-infrared ray may also be provided on an inner surface of the housing. By the above-described configuration, heat generated by the heating unit 20 is transferred to the entire housing 10 even when the cup or container does not directly contacts the housing 10, and it is possible to more effectively heat the cup or container accommodated in the housing 10, and contents therein, as convective heat, radiant heat, and far-infrared ray are generated in the housing 10. In addition, as a heating apparatus, a plane heater or a Peltier element may be provided to the housing. Meanwhile, the Peltier element may also perform a cooling function.

Further, the side wall portion of the housing 10 may be formed to have a predetermined gradient. By the above-described configuration, the side wall portion of the housing 10 may more closely contact the cup or container having a gradient, such that the heat may be more effectively transferred to the cup or container from the housing 10.

The heating unit 20 includes a thermally conductive plate 21 (See FIG. 2) formed of metal having excellent thermal conductivity, and for example, a thin heater or a plane heater 25 or a plane positive temperature coefficient (PTC) heater 25 that is buried in the thermally conductive plate 21 as a heating means (See FIG. 2). The heating unit 20 may be disposed at a portion of a side portion of the housing 10 to be adjacent to the cup or container 1 accommodated in the housing 10 or contact the cup or container 1. Although one heating unit 20 is disposed in the present exemplary embodiment, it is apparent that two or more heating units 20 may be disposed.

Further, the cup holder 100 may further include the lighting part 30 emitting light to inform a user that heat is being applied to the cup or container 1 accommodated in the housing 10 of the cup holder 100. The lighting part 30 may be formed of an optical fiber, LED, or the like. The lighting part 30 may also be operated together with night lighting in the vehicle. In the lighting part 30, as will be described below, a color of light at the time of indicating heating and a color of light at the time of night lighting may be different from each other.

In addition, the cup holder 100 may further include a ring cover 40 capable of covering an edge portion of the housing 10. The ring cover 40 may be manufactured with a translucent material allowing light emitted from the lighting part 30 to be transmitted therethrough. Alternatively, only an inner edge 43 of the ring cover 40 may be manufactured with a transparent material to allow light emitted from the lighting part 30 to be transmitted therethrough.

Further, the ring cover 40 may be provided with a switch 41 allowing or blocking supply of power to the lighting part 30 and the plane heater 25 of the heating unit 20 of the cup holder 100. Further, the ring cover 40 may also be provided with, for example, a temperature adjusting part capable of adjusting an amount of heat generated from the heating unit 20 by adjusting a current amount using variable resistance, etc.

Hereinafter, the heating unit 20 of the cup holder 100 will be described with reference to FIG. 2. FIG. 2 illustrates a perspective view of the heating unit 20 according to an exemplary embodiment of the present invention. The thermally conductive plate 21 of the heating unit 20 may be formed by extruding metal such as copper or aluminum with high thermal conductivity. The thermally conductive plate 21 includes a first thermally conductive surface 22, a second thermally conductive surface 23, and a rear surface 28 disposed at an opposite side to the these thermally conductive surfaces 22 and 23. The first thermally conductive surface 22 and the second thermally conductive surface 23 may be connected to each other at an angle of less than 180 degrees, and a connection line 24 may be formed at a connection portion. As such, since the first thermally conductive surface 22 and the second thermally conductive surface 23 are connected to each other while forming an angle of less than 180 degrees therebetween, when the cup or container 1 accommodated in the housing 10 has a circular shape, the first thermally conductive surface 22 and the second thermally conductive surface 23 may contact the cup or container 1 at two points, which may increase efficiency of heat transfer to the cup or container 1 from the heating unit 20, as compared to a case in which a thermally conductive surface is a circular arc.

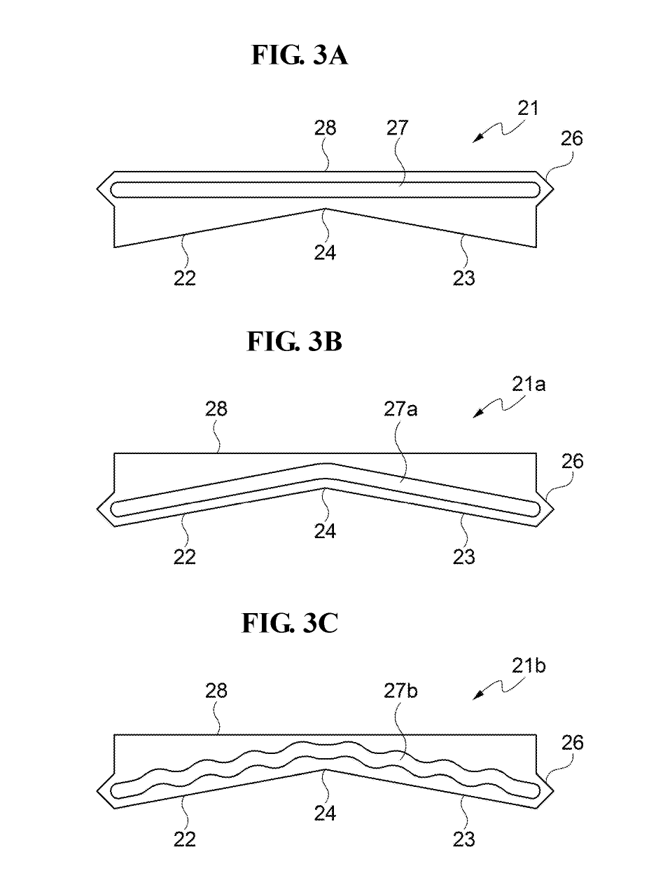

The plane heater 25 may be buried in the thermally conductive plate 21. As described below, after the plane heater 25 is inserted into an insertion hole 27 (See FIG. 3) formed in the thermally conductive plate 21, the rear surface 28 is pressurized such that a gap in the insertion hole 27 is decreased, that is, the insertion hole 27 is compressed, thereby burying the plane heater 25 in the thermally conductive plate 21.

The plane heater 25 is formed by coating a strip-type plane heating element such as a thin metal plate having a small thickness with a synthetic resin having excellent heat resistance and electric insulation property, for example, an insulating film formed of polyimide. It is possible to perform low temperature heating in a wide area, and have high heat transfer efficiency. Further, ceramic coating may also be used instead of the insulating film. The plane heater 25 is a known technology, thus description thereof will be omitted.

The heating unit 20 may further include an insulation member 29 disposed between the plane heater 25 and the rear surface 28, in the insertion hole 27. The insulation member 29 suppresses heat generated in the plane heater 25 from being radiated to the outside through the rear surface 28. With this, a large part of the heat generated in the plane heater 25 may be radiated toward the cup or container 1 accommodated in the housing 10 through the first thermally conductive surface 22 and the second thermally conductive surface 23. Further, a reflection layer may also be provided in the insulation member 29, and in this case, the insulation member 29 may also have a function of reflecting heat in addition to the function of simply suppressing transfer of heat.

The thermally conductive plate 21 of the heating unit 20 may further include bent parts 26 formed at both side portions thereof. The bent part 26 has a cross section having a shape of an inequality sign “<” or “>”, or a parenthesis “(” or “)”, and the bent part 26 may be bent when the gap in the insertion hole 27 is decreased as the rear surface 28 and the first and second thermally conductive surfaces 22 and 23 closely adhere to each other. Accordingly, the insertion hole 27 may be more easily compressed. Further, the bent part 26 may be inserted into a groove (not illustrated) formed in the housing 10 at the time of assembling the heating unit 20 and the housing 10.

The case in which the thermally conductive plate 21 is formed of metal has been described above, but the thermally conductive plate 21 may be formed of thermally conductive plastic. In this case, the thermally conductive plate 21 may be formed by insert injection-molding or insert molding on the plane heater 25 so that the plane heater 25 may be buried in the thermally conductive plate 21 or adhered to one surface, for example, the rear surface 28.

Further, the plane heater 25 may be firmly adhered to one surface of the thermally conductive plate 21, for example, the rear surface 28 by a thermally conductive adhesive having excellent thermal conductivity. The thermally conductive adhesive may be formed of, for example, a bisphenol A-based liquid epoxy resin as a main component. The thermally conductive adhesive is a known technology, thus detailed description thereof will be omitted.

FIGS. 3A to 3C illustrate plan views of thermally conductive plates 21, 21a, and 21b of the heating units 20 according to various exemplary embodiments of the present invention. The exemplary embodiments illustrated in FIGS. 3A to 3C have insertion holes 27, 27a, and 27b having different shapes, respectively.

Referring to FIG. 3A, the insertion hole 27 is formed along the rear surface 28 while being adjacent to the rear surface 28, and has a straight line shape. The bent parts 26 are disposed at both end portions of the insertion hole 27. The bent part 26 may be easily bent when the gap in the insertion hole 27 is decreased, and may be bent inwardly so that the gap in the insertion hole 27 may completely disappear.

Referring to FIG. 3B, the insertion hole 27a is formed along the first and second thermally conductive surfaces 22 and 23 while being adjacent to the first and second thermally conductive surfaces 22 and 23, and has a bent shape. By the above-described configuration, since the plane heater 25 is disposed to be adjacent to the first and second thermally conductive surfaces 22 and 23, heat may be more rapidly radiated from these surfaces 22 and 23. The bent parts 26 as described above are disposed at both end portions of the insertion hole 27a.

Referring to FIG. 3C, the insertion hole 27b is formed along the first and second thermally conductive surfaces 22 and 23 while being adjacent to the first and second thermally conductive surfaces 22 and 23, and has a wave shape or a zigzag shape. By the above-described configuration, a plane heater 25 having a larger width may be inserted into the thermally conductive plate 21 having the same width, thereby increasing an amount of heat radiated. The bent parts 26 as described above are disposed at both end portions of the insertion hole 27b.

Further, the thermally conductive plates 21, 21a, and 21b illustrated in FIGS. 3A to 3C have a flat rear surface 28, but the rear surface 28 may be formed in parallel to the first and second thermally conductive surfaces 22 and 23. In addition, the insertion hole may have a shape other than the illustrated shapes.

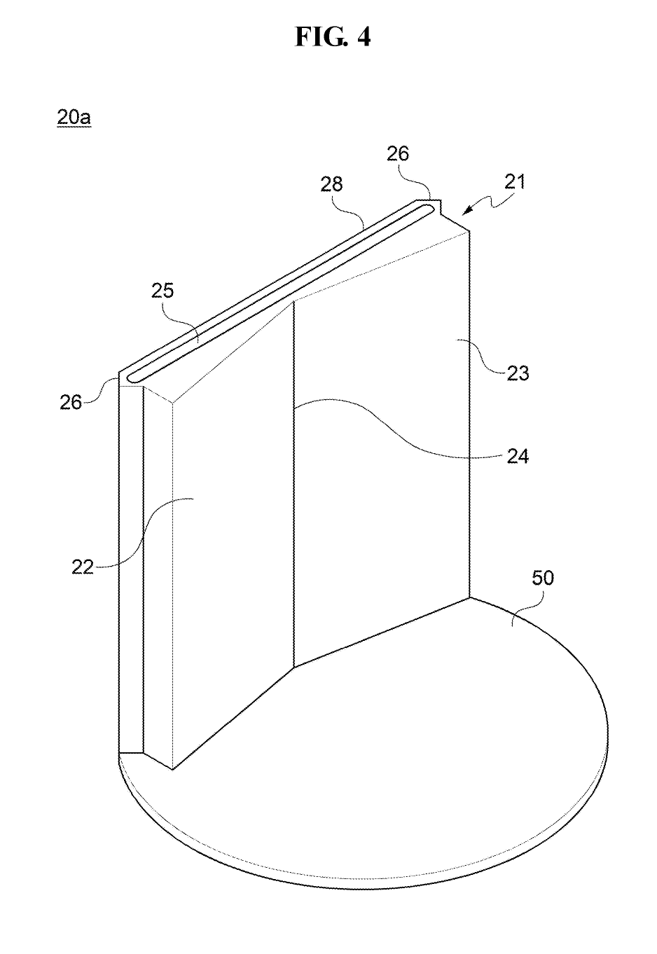

FIG. 4 is a perspective view of a heating unit according to another exemplary embodiment of the present invention.

As illustrated in FIG. 4, a heating unit 20a according to another exemplary embodiment of the present invention further includes a bottom part 50. The bottom part 50 has the same shape as that of the cross section of the housing 10, for example, a circular shape, and may be connected to a lower end of the thermally conductive plate 21. The bottom part 50 may be formed of the same metal as the thermally conductive plate 21 and integrally formed with the thermally conductive plate 21. The heat generated in the plane heater 25 that is buried in the thermally conductive plate 21 may be transferred to the bottom part 50 as well through the thermally conductive plate 21. By the above-described configuration, the heat may be transferred to the cup or container 1 even at a lower portion of the cup or container 1 accommodated in the housing 10, such that the heat may be effectively transferred to contents in the cup or container 1. Further, the plane heater may also be provided at a lower portion of the bottom part 50. In this case, an insertion hole that is similar to the insertion hole 27 formed in the thermally conductive plate 21 may also be formed in the bottom part 50.

The bottom part 50 may be connected to the first thermally conductive surface 22 and the second thermally conductive surface 23 of the thermally conductive plate 21 at an angle of 90 degrees. Therefore, the thermally conductive plate 21 and the bottom part 50 may closely adhere to a bottom portion and a side wall of the cup or container 1 inserted into the housing 10.

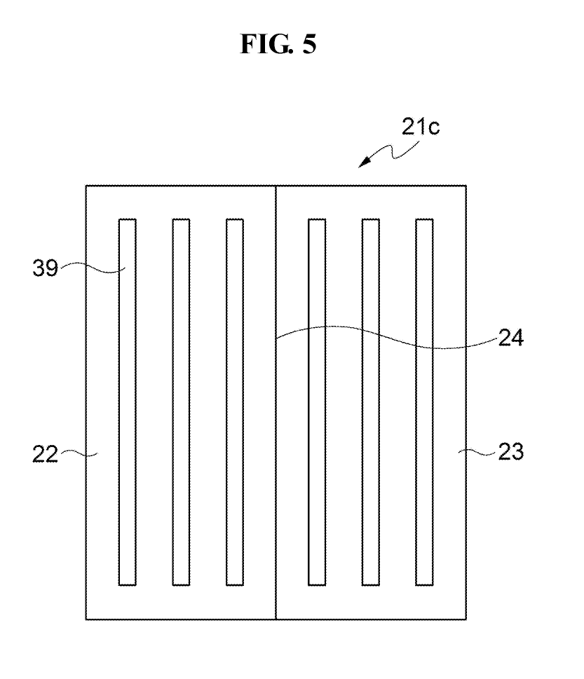

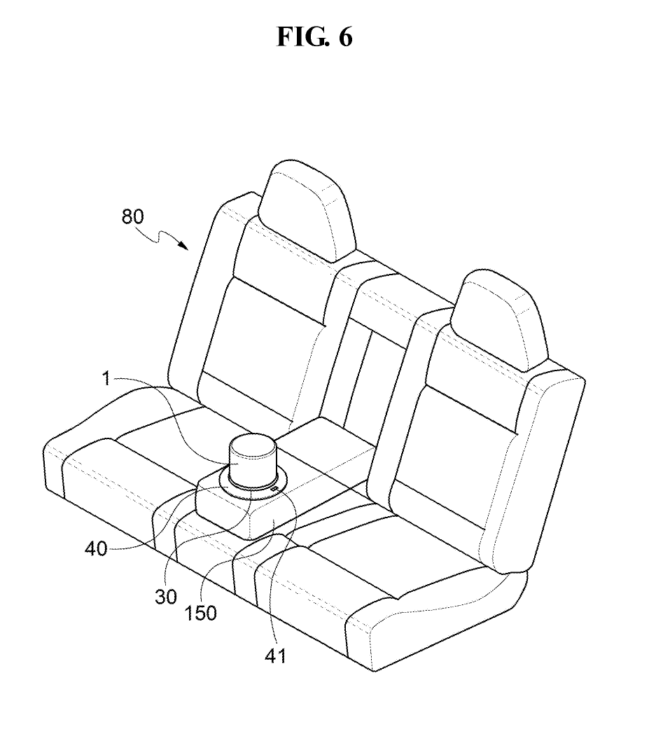

FIG. 5 is a front view of a thermally conductive plate according to still another exemplary embodiment of the present invention.

As illustrated in FIG. 5, concave parts or cutout parts 39 are formed on the first thermally conductive surface 22 and the second thermally conductive surface 23 of the thermally conductive plate 21c according to the still another exemplary embodiment. The concave parts or cutout parts 39 may be vertically formed. Alternatively, the concave parts or cutout parts 39 may be formed to have different shapes other than a vertical shape. The concave parts or cutout parts 39 help rapid radiation of the heat generated in the plane heater 25 that is buried in the thermally conductive plate 21c through the first and second thermally conductive surfaces 22 and 23. Alternatively, the first and second thermally conductive surfaces 22 and 23 may also have protrusions that are not illustrated.

FIG. 6 is a perspective view of a cup holder 100 according to an exemplary embodiment of the present invention installed in the vehicle.

As illustrated in FIG. 6, the cup holder 100 may be installed in, for example, an armrest 150 of a rear seat in the vehicle. In FIG. 6, a case in which one cup holder 100 is installed is illustrated, but two or more cup holders 100 may be installed. When the switch 41 provided at the ring cover 40 of the cup holder 100 is turned on, power is supplied to the lighting part 30, and when the lighting part 30 emits light, a red light is lit in the inner edge 43 of the ring cover 40. Further, at this point, power is supplied to the plane heater 25 of the heating unit 20 to generate heat.

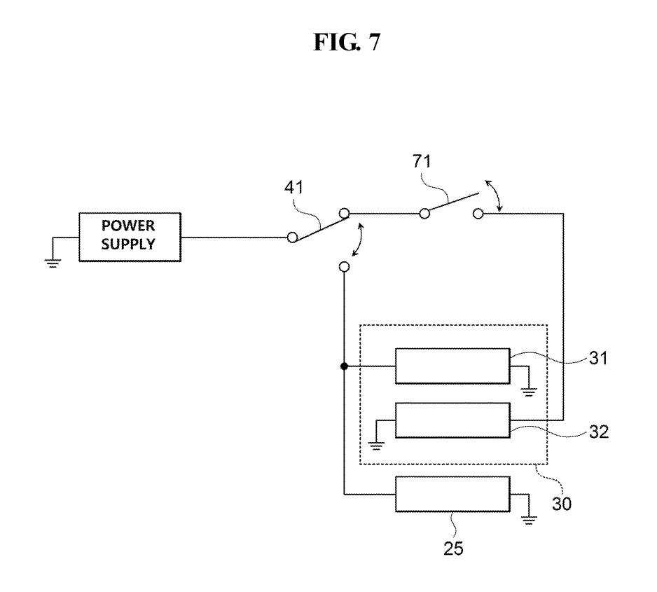

In addition, as described below, for example, when an internal lighting is turned on in the vehicle at the time of night driving, as power is supplied to the lighting part 30 through a different line other than a line illustrated in FIG. 1, the lighting part 30 may also be configured to emit light having different color other than red. Even in the case, when the switch 41 is turned on, the lighting part 30 may emit red light. Description in relation to this will be provided with reference to FIG. 7. That is, the switch 41 is connected to a night lighting switch 71 in a normal state. Therefore, when the night lighting switch 71 is turned on, power is supplied to, for example, a second lighting 32 emitting yellow light, of the lighting part 30, and when the switch 41 is turned on, power is not supplied to the second lighting 32 but power is supplied to, for example, a first lighting 31 emitting red light, of the lighting part 30, and the plane heater 25. Here, the night lighting switch 71 may be provided at, for example, combination switches attached to a side portion of a handle of a vehicle.

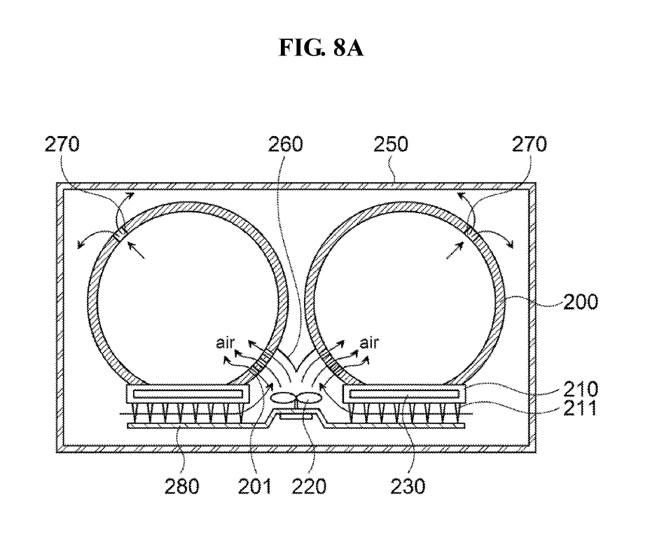

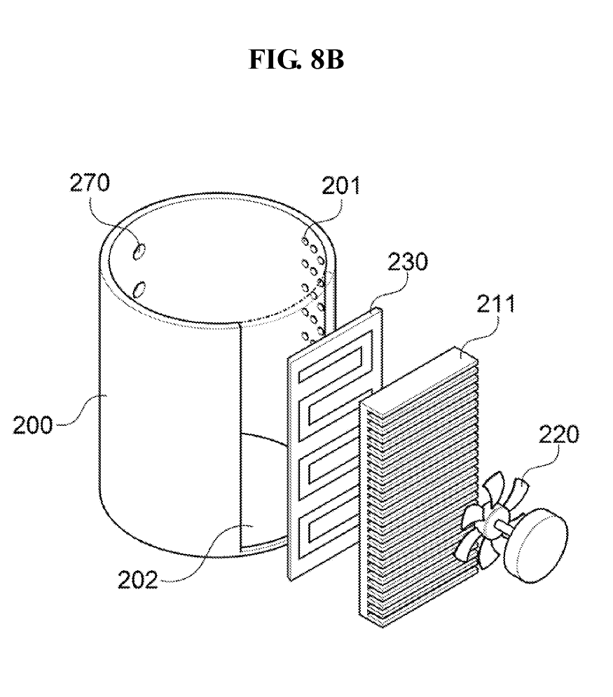

FIGS. 8A and 8B are a cross-sectional view of a cup holder for a vehicle according to still yet another exemplary embodiment of the present invention, and a partial exploded perspective view of the cup holder, respectively.

As illustrated in FIGS. 8A and 8B, the cup holder for a vehicle according to still yet another exemplary embodiment of the present invention may be installed in, for example, the armrest in the vehicle, etc., and includes a cup holder body 250; a housing 200 for accommodating an accommodated item like a cup or container; a heat exchanger 210 mounted at one side surface of the housing 200 and including a heater 230 and a heat exchanging fin 211; a hole 201 formed in a wall portion of the housing 200 to communicate between an inside and an outside of the housing 200; and an air-blowing fan 220 for supplying air heated by the heat exchanger 210 to the inside of the housing 200 through the hole 201.

The cup holder body 250 may accommodate the housing 200, the heat exchanger 210 installed at the housing 200, the air-blowing fan 200, a distribution guide part 260 disposed between two housings to guide air flew by the air-blowing fan 200 to the hole 201 of the housing 200, and a flow path guide part 280 forming a flow path through which the air may flow, together with the heat exchanger 210, in a sealing manner, and an opening part of the housing 200 is opened to the outside of the cup holder body 250. Further, the cup holder body 250 may be formed of an insulation material capable of suppressing internal heat from being leaked to the outside, or may have an insulating layer provided therein.

The hole 201 formed in the housing 200 may be formed to be adjacent to a heater attachment part 202 where the heat exchanger 210 is attached to the housing 200. The heater attachment part 202 may be formed of metal having high thermal conductivity, etc., therefore, heat generated in the heater 230 may be efficiently transferred to the accommodated item that is accommodated in the housing 200. Alternatively, a cutout part may be formed at the heater attachment part 202, the heater 230 may be buried in the heat exchanging fin 211, and the heat exchanging fin 211 may be mounted at the heater attachment part 202.

The heater 230 of the heat exchanger 210 may be configured by, for example, a thin heater or plane heater, or a plane positive temperature coefficient (PTC) heater. The heat exchanging fin 211 of the heat exchanger 210 may be closely adhered to the heater 230 or the heater 230 may be buried therein. The heat exchanging fin 211 may heat ambient air with heat generated in the heater 230.

The air-blowing fan 220 may be disposed between, for example, two housings 200, mounted at the flow path guide part 280 to be described below, and operated by being supplied with power when power is supplied to the heater 230. Once the air-blowing fan 220 is operated, air heated by the heat exchanger 210 flow into the housing 200 through the hole 201 of the housing 200. The heated air introduced into the housing 200 heats the accommodated item such as a cup or container accommodated in the housing 200 and then is discharged to the outside of the housing 200 through an outlet 270 of the housing 200. The discharged air may be recirculated to the housing 200 again by an air guide part formed in the cup holder body 250. That is, the air discharged through the outlet 270 of the housing 200 is guided by the cup holder body 250 accommodating the housing 200 to be moved to the heat exchanger 210 again, is heated by the heat exchanger 210 again, and is introduced into the housing 200 again through the hole 201 of the housing 200. Alternatively, the air guide part may also be formed by an independent duct that is not illustrated. Here, the air discharged through the outlet 270 of the housing 200 still has a part of heat received from the heat exchanging fin 211, thus when being heated by the heat exchanger 210 again, may be heated to a higher temperature as compared to previous heating.

Further, at this point, the flow path formed by the flow path guide part 280 that is disposed to face the heat exchanger 210 while being spaced apart from the heat exchanger 210, and the heat exchanger 210 may form a part of the air guide part. Air passing through the flow path formed as described above may more effectively contact the heat exchanging fin 211 of the heat exchanger 210, and therefore, heat exchange between the air and the heat exchanging fin 211 may be efficiently performed.

Further, as in the present exemplary embodiment, when two or more housings 200 are installed, a guide part 260 may be provided between the housings 200, such that it is possible to split air flew by the air-blowing fan 220 in two parts, thereby uniformly distributing the air to the two housings 200.

As described above, the present invention has been described based on exemplary embodiments, but it will be apparent to those having ordinary knowledge in the art to which the present invention pertains that various modifications are possible without departing from the technical idea of the present invention.

Further, it will be also apparent to those having ordinary knowledge in the art to which the present invention pertains that constituent elements of the present invention may be substituted or modified with known technical elements performing similar functions.

Accordingly, the scope of the present invention should not be limited to the described exemplary embodiments, but the idea claimed in claims below and equivalents thereof fall within the scope of the present invention.

### DETAILED DESCRIPTION OF MAIN ELEMENTS

1: Cup or container
10: Housing
11: Cutout part
20; 20a: Heating unit
21; 21a; 21b; 21c: Thermally conductive plate
22: First thermally conductive surface
23: Second thermally conductive surface
24: Connection line
25: Plane heater
26: Bent part
27: Insertion hole
28: Rear surface
29: Insulation member
30: Lighting part
31: First lighting
32: Second lighting
39: Cutout part
40: Ring cover
41: Switch
71: Night lighting switch
80: Rear seat
100: Cup holder
150: Armrest

1. A cup holder for a vehicle, comprising:
a housing for accommodating a cup or container; and
a heating unit disposed at a portion of a side wall of the housing,
wherein the heating unit is provided with a thermally conductive plate and a plane heater fixedly disposed on one surface or in the inside of the thermally conductive plate.

2. The cup holder for a vehicle of claim 1, wherein the thermally conductive plate is formed of metal, and formed with an insertion hole that is compressed after the plane heater is inserted thereinto so that the plane heater is buried in the thermally conductive plate.

3. The cup holder for a vehicle of claim 1, wherein the thermally conductive plate includes a first thermally conductive surface and a second thermally conductive surface that contact the cup or container accommodated in the housing, the first thermally conductive surface and the second thermally conductive surface being connected to each other at an angle of less than 180 degrees.

4. The cup holder for a vehicle of claim 2, wherein the thermally conductive plate includes a first thermally conductive surface and a second thermally conductive surface that contact the cup or container accommodated in the housing, the first thermally conductive surface and the second thermally conductive surface being connected to each other at an angle of less than 180 degrees, and the insertion hole is formed to have a bent shape while being adjacent to the first and second thermally conductive surfaces.

5. The cup holder for a vehicle of claim 2, wherein the thermally conductive plate includes a first thermally conductive surface and a second thermally conductive surface that are connected to each other at an angle of less than 180 degrees, and further includes a rear surface facing the first and second thermally conductive surfaces, and the insertion hole is formed to have a straight line shape while being adjacent to the rear surface.

6. The cup holder for a vehicle of claim 2, wherein the insertion hole is formed to have a wave shape or a zigzag shape.

7. The cup holder for a vehicle of claim 2, wherein a bent part that is bent when the insertion hole is compressed is formed at a portion adjacent to at least one of both ends of the insertion hole of the thermally conductive plate.

8. The cup holder for a vehicle of claim 2, further comprising an insulation member disposed at a surface, of both surfaces of the plane heater buried in the thermally conductive plate, that is far from a surface of the thermally conductive plate facing the cup or container accommodated in the housing.

9. The cup holder for a vehicle of claim 2, wherein the thermally conductive plate includes a first thermally conductive surface and a second thermally conductive surface that contact the cup or container accommodated in the housing, at least one of the first thermally conductive surface and the second thermally conductive surface is formed with a cutout part.

10. (canceled)

11. The cup holder for a vehicle of claim 1, further comprising a lighting part disposed to be adjacent to a circumference of an opened upper end portion of the housing, and emitting light with a first color when power is supplied to the plane heater,
wherein the lighting part emits light with a second color when night lighting is turned on in the vehicle, and emits light with the first color when power is supplied to the plane heater.

12. The cup holder for a vehicle of claim 1, wherein the plane heater is a positive temperature coefficient (PTC) heater.

13. The cup holder for a vehicle of claim 1, wherein the thermally conductive plate is formed of thermally conductive plastic, and the plane heater is buried in the thermally conductive plate or adhered to one surface of the thermally conductive plate by insert injection-molding or insert molding.

14. (canceled)

15. The cup holder for a vehicle of claim 1, wherein
the housing is formed of metal,
and at least a portion of the housing is provided with an infrared ray coating layer for generating infrared ray.

16. The cup holder for a vehicle of claim 1,
wherein a side wall portion of the housing has a predetermined gradient to facilitate contact with the cup or container.

17. (canceled)

18. The cup holder for a vehicle of claim 16, further comprising a plane heating element or a Peltier element provided in the housing.

19. (canceled)

20. A cup holder for a vehicle, wherein air heated by a heater and a heat exchanging fin is supplied to an inside of a housing by an air-blowing fan to heat an accommodated item accommodated in the housing.

21. (canceled)

22. The cup holder for a vehicle of claim 20 or 21, wherein a coating for generating far-infrared ray is formed.

23. A cup holder for a vehicle, comprising:
a housing for accommodating a cup or container;
a heat exchanger mounted at the housing to transfer heat to the cup or container accommodated in the housing and heat air outside the housing;
an air-blowing fan disposed to be adjacent to the heat exchanger; and
an air guide part guiding air to flow from the housing to the heat exchanger,
wherein the housing is formed with a hole through which air is introduced and an outlet through which air is discharged, and the air guide part is formed from the outlet of the housing to the hole of the housing, such that the air heated by the heat exchanger is supplied to an inside of the housing by the air-blowing fan through the hole of the housing and air in the inside of the housing is discharged through the outlet to the outside of the housing and flows to the heat exchanger again.

24. The cup holder for a vehicle of claim 23, wherein the air guide part is formed by a cup holder body accommodating the housing, the heat exchanger, and the air-blowing fan therein, or by an independent duct.

25. The cup holder for a vehicle of claim 23, further comprising a flow path guide part disposed to face the heat exchanger while being spaced apart from the heat exchanger,
wherein a part of the air guide part is formed by the heat exchanger and the flow path guide part.

26. (canceled)
